(19) United States
(12) Patent Application Publication
(10) Pub. No.: US 2011/0123175 A1
(43) Pub. Date: May 26, 2011

(54) DISC PROTECTION SCHEME

(75) Inventors: Serhiy Tkachenko, Geldrop (NL); Victor Shcherbatyuk, Eindhoven (NL); Ilija Pjanovic, Eindhoven (NL)

(73) Assignee: KONINKLIJKE PHILIPS ELECTRONICS, N.V., EINDHOVEN (NL)

(21) Appl. No.: 11/721,471

(22) PCT Filed: Dec. 13, 2005
(86) PCT No.: PCT/IB2005/054196

§ 371 Date: Aug. 27, 2009

(30) Foreign Application Priority Data
Dec. 20, 2004 (EP) 04106705.9

(51) Int. Cl. H04N 9/80

(52) U.S. Cl. 386/252; 386/E05.003

(57) ABSTRACT

The invention relates to a portable storage medium, a media player and a method of disturbing the perception of content provided in a first media stream. The first media stream is combined with other media streams to at least one transport stream and provided, together with at least one second media stream, on the portable storage medium. The media player includes a control unit, which retrieves a playing control unit from the storage medium and implements it, (step 37), receives a user selection of reproducing content provided in the first media stream, (step 40), selects the second media stream for presentation in relation to the first media stream based on the user selection, (step 44), and presents content provided in the second media stream in relation to the first media stream so that the content of the second media stream disturbs the perception of content provided in the first media stream, (step 48).

### FIELD OF THE INVENTION

The present invention generally relates to protection of content provided in media streams and more particularly to a portable storage medium, a media player and a method of disturbing the perception of content provided in a first media stream.

### BACKGROUND OF THE INVENTION

In recent years, a number of standards for recording multimedia data on portable storage mediums have been developed, for example, DVD (Digital Versatile Disc) and Blu-ray disc video. Different media streams are provided, which are multiplexed with each other into transport streams. A user can then also select the streams to be presented, for example, different audio language streams and different subtitle streams, depending on the relevant country.

When providing content on such a disc, it is advantageous to provide a limited version of the content, which limited version forms a subset of the whole content. This limited version can then be distributed freely for informing potential customers of some of the key features of the content. Once a customer purchases the content, he is given a full version of the content. This is normally done by providing separate discs, one with the limited version and the other with the full version. This is both a complex and expensive way of providing the content. It would therefore be beneficial if one and the same disc were used for both the limited version and the full version.

One way of doing so is presented in US-2003/0163724, wherein a masking effect is provided as an overlay, interruption, interference, disturbance or disorientation on an information product, for which an information object can be provided as image, video, audio, etc. The information product is provided on a server and streamed to a user, but can also be provided on a CD ROM storage media.

In view of the prior art, it would be advantageous to provide an improved way of disturbing the perception of content provided on a portable storage medium.

### OBJECT AND SUMMARY OF THE INVENTION

It is therefore an object of the present invention to provide an improved way of disturbing the perception of content provided on a portable storage medium.

According to a first aspect of the present invention, this object is achieved by a portable storage medium to be used in a media player for disturbing the perception of content provided in a first media stream, the medium having stored thereon:

at least one transport stream comprising the first media stream combined with other media streams, as well as a second media stream also provided in a transport stream, and

a computer program code, which, when loaded into the media player, causes said media player to implement,

a playing control unit set to

select, on the basis of a user selection of reproducing content provided in the first media stream, the second media stream for presentation in relation to the first media stream, and

order the presentation of content provided in at least a part of the second media stream in relation to a corresponding part of the first media stream so that the content of the second media stream disturbs the perception of content provided in the first media stream.

According to a second aspect of the present invention, the object is also achieved by a media player for disturbing the perception of content provided in a first media stream, said first media stream being combined with other media streams to at least one transport stream and being also provided, together with at least one second media stream, in a transport stream on a storage medium, the media player comprising:

a control unit arranged to retrieve and implement a playing control unit from said storage medium, which playing control unit is set to

select, on the basis of a user selection of reproducing content provided in the first media stream, the second media stream for presentation in relation to the first media stream, and

order the presentation of content provided in at least a part of the second media stream in relation to a corresponding part of the first media stream so that the content of the second media stream disturbs the perception of content provided in the first media stream.

According to a third aspect of the present invention, the object is also achieved by a method of disturbing the perception of content provided in a first media stream, said first media stream being combined with other media streams to at least one transport stream and being also provided, together with at least one second media stream, in a transport stream on a portable storage medium, the method comprising the steps of

retrieving a playing control unit from said storage medium and implementing it,

receiving a user selection of reproducing content provided in the first media stream,

selecting the second media stream for presentation in relation to the first media stream based on the user selection, and

presenting content provided in at least a part of the second media stream in relation to a corresponding part of the first media stream so that the content of the second media stream disturbs the perception of content provided in the first media stream.

Disturbing the perception of content is realized in a simple way by means of the present invention, using the existing command structure provided on a portable storage medium. In this way, it is possible to avoid the use of additional complex measures for disturbing content. This has the further advantage of allowing the content provider full control of the measures performed for disturbing content. The invention also allows the use of the same storage medium for providing preview and full copies of content, which reduces the production costs of such portable storage mediums. Moreover, there is no need for editing the content in order to remove the measure that disturbs the content after a purchase; it can simply be switched off after a verified purchase.

As defined in claim 2, the second stream is of a type provided on the medium for ordinary purposes of presenting information. This feature has the advantage of using the type of streams already provided on a disc for other purposes to achieve disturbing of content. In this way, additional streams and complex additional measures for disturbing the perception of content are avoided.

As defined in claims 3 and 4, the playing control unit comprises a number of command modules, at least one of which is activated when a user selects playing of a stream, which is set to perform said selection and order the presentation. This measure allows a fast and simple implementation of a measure for disturbing the perception of content.

As defined in claims 5 and 6, the playing control module comprises a number of media stream control modules, each media stream control module comprising at least one play item control module that can be activated by a command module and controls the playing of at least a part of at least one transport stream. A stream allocation table is also associated with said play item control module and lists allowable streams for the play item control module, wherein the selection of said second media stream is made in dependence upon a setting in said stream allocation table and said ordering of the presentation is performed through the command module activating the play item control module. This allows the set-up of a command module to select a play item control module, when the perception of content is to be disturbed, and another play item control module when it is not to be disturbed.

As defined in claim 7, a user operation table associated with said play item control module is provided, which table comprises a list of allowable user commands and is associated with a play item control module being controlled by the activated command module having at least one setting which disallows the change of commands related to removing the presentation of at least said second media stream. This measure has the advantage of ensuring that a user cannot remove a measure that has been applied for disturbing the perception of content.

As defined in claim 8, the first media stream is a video stream, the second media stream is a stream comprising additional visual information and the playing control module is arranged to present the second stream over said first stream for disturbing the perception of the content of the first stream. This measure has the advantage of using additional graphics and/or subtitle streams which are normally provided on a medium for disturbing the perception of content.

As defined in claim 9, the second stream is a media stream with embedded user-selectable commands, the commands being set to disturb the perception of the content of the first media stream and disregard user selections. This feature has the advantage of using an existing stream type, which is normally used for allowing user interaction, for disturbing the perception of content. Moreover, the use of such a stream makes it possible to provide several different measures that regularly disturb the perception of content.

As defined in claim 10, the first media stream is a video stream, the second media stream is also a video stream of the same content with a lower quality, and the playing control module is arranged to present the second stream instead of the first stream. This feature has the advantage of allowing the use of different angles of video, which are provided for content in order to disturb the perception of content. In this way, the measure for disturbing the perception of content can be provided with different codes of the same content, which is a very limited additional effort that can be implemented at low additional cost.

As defined in claim 11, the first media stream is an audio stream that is combined with a video stream, the second media stream is also an audio stream, and the playing control module is arranged to present the second stream instead of the first stream for disturbing the perception of content of the first media stream. This feature has the advantage of allowing the use of existing audio streams normally provided for other purposes for disturbing the perception of sound.

According to an optional feature of the present invention, the first and second streams are provided in different transport streams.

According to another optional feature of the present invention, the first and second streams are provided in the same transport stream.

The basic idea of the invention is to use the command structure already provided on a storage medium for disturbing the perception or masking the content provided on the medium. In this way, it is possible to avoid the use of additional complex measures for disturbing content.

The above-mentioned and other aspects of the invention are apparent from and will be elucidated with reference to the embodiments described hereinafter.

### BRIEF DESCRIPTION OF THE DRAWINGS

The present invention will be further described with reference to the accompanying drawings, in which:

FIG. 1 schematically shows a command structure provided for playing clips of media data together with such clips,

FIG. 2 schematically shows a clip comprising a transport stream together with a corresponding clip information file,

FIGS. 3a and b schematically show two EP-tables provided in the clip information file of FIG. 2,

FIG. 4 schematically shows a stream allocation table associated with a stream control module of FIG. 1,

FIG. 5 schematically shows a user operation table also associated with the stream control module of FIG. 1,

FIG. 6 schematically shows the presentation of an interactive graphics stream on top of a video stream,

FIG. 7 schematically shows a portable storage medium according to the present invention, comprising the clips together with software for providing the command structure shown in FIG. 1,

FIG. 8 is a block diagram of a media player arranged to provide the command structure of FIG. 1 as well as playing the clips also provided in FIG. 1, and

FIG. 9 is a flow chart of a method of disturbing the perception of content according to the present invention.

### DESCRIPTION OF EMBODIMENTS

The present invention generally relates to disturbing the perception of media content on a portable storage medium. A portable storage medium is normally an optical disc. However, other types of mediums are also possible for use in the present invention, such as, for instance, memory sticks. Before the details of disturbing the perception of media content according to the present invention are further described, the general structure of the way in which information is provided on such a storage medium and how it is used for controlling media streams will be described first.

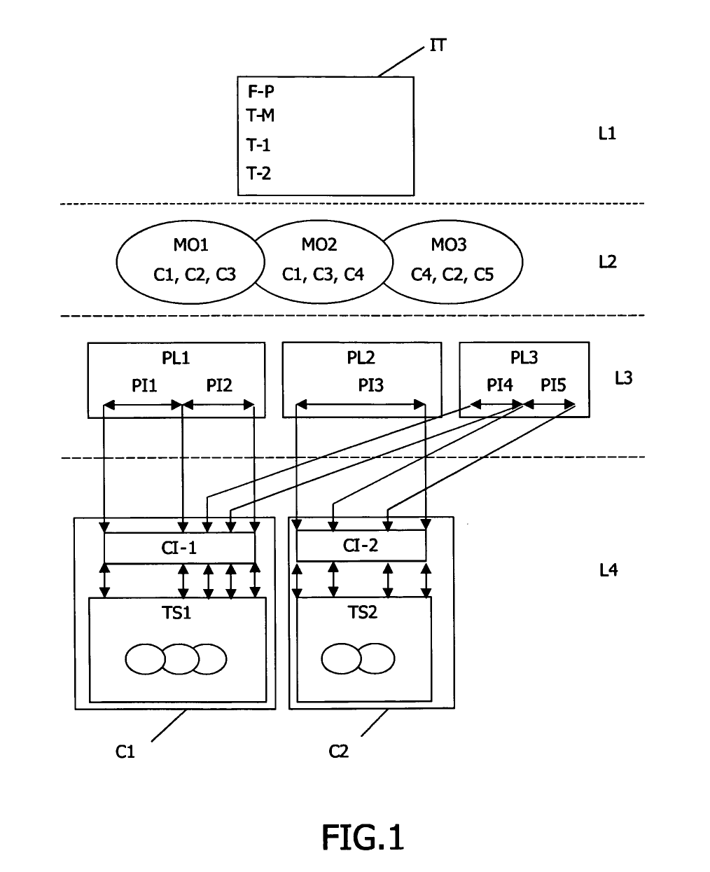

FIG. 1 is a schematic drawing of a media content command structure provided by a computer program code on a portable storage medium. The content command structure is operative when the computer program code is loaded in a memory and run on a suitable processor, which is normally present in a media player. The structure is grouped into different layers L1, L2 and L3 that make up a structure for a playing control unit. Another layer LA provides media content which is controlled by the playing control unit. A first top layer L1 includes an Index table IT comprising a first playback item FP, a top menu item T-M, a first title item T-1, and a second title item T-2. This layer L1 is adapted to communicate with a user interface via which a user can access the media content on the medium. This top layer L1 covers a second layer L2 comprising a number of command modules, which are here also called Movie Objects MO1, MO2, MO3. These movie objects MO1, MO2 and MO3 are activated by items in the index table IT in the top layer L1 on the basis of user inputs. A third layer L3 comprises a number of media stream control modules in the form of Play Lists PL1, PL2 and PL3 each having one or more play item control modules PI, which will hereinafter be denoted as play items. The play items PI point at data in a fourth layer L4, which data is provided in the form of clips C1 and C2 each comprising a transport stream TS1 and TS2 of multiplexed media streams together with corresponding overhead data in the form of clip information files CI-1 and CI-2.

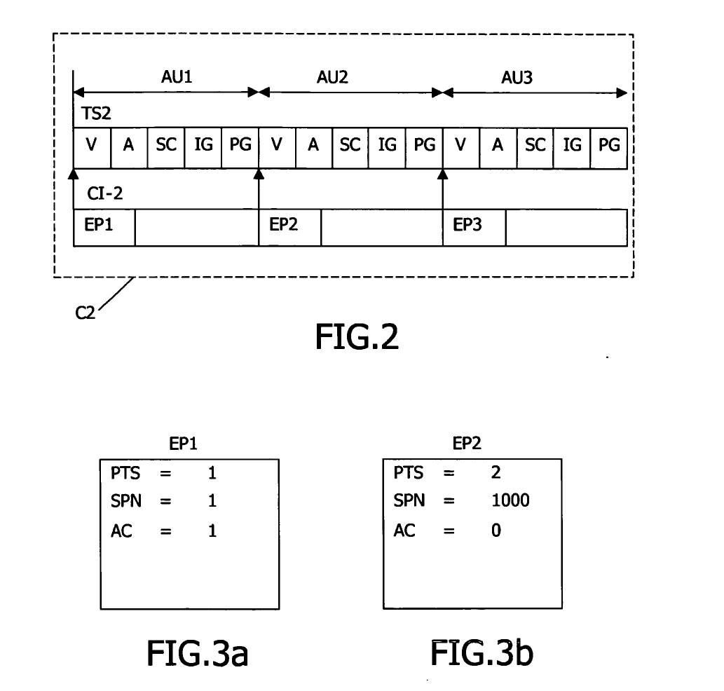

Clip information files and transport streams are described with reference to FIG. 2, which shows one transport stream TS2 together with a corresponding clip information file CI-2. A transport stream TS includes MPEG coded video V packets and Dolby AC-3 coded audio packets A together with stream control packets SC, as well as interactive graphics IG and presentation graphics, and text PG packets. An interactive graphics stream will be described hereinafter. A presentation graphics and text stream provides additional graphics and text. The presentation graphics and text stream is provided as two-dimensional run-length encoded raster images together with control information for placement of images, colors, etc. The streams are divided into access units, only three of which, AU1, AU2 and AU3 are shown. It should be realized that there are normally several more access units. In order to simplify the description, each access unit only includes one packet of each type in the Figure. It should, however, be realized that in reality there are normally several packets of each type in each access unit. Furthermore, the total number of packets in the access units is preferably normalized, so that each of them includes the same amount of packets in order to simplify switch-over between different transport streams. Another term frequently used for an access unit is “frame”. The streams are provided with presentation time stamps PTS as well as source packet numbers SPN and the clip information file CI-2 includes EP-tables including information pointing at the entry and exit points of the transport streams in order to allow switch-over between different transport streams and also switch-over between different parts of the same stream.

FIG. 3A shows an example of such an EP table EP1 provided in the clip info file CI-2 and pointing at the first video packet of the first access unit AU1. Here, there is provided a first presentation time stamp PTS and a first source packet number SPN, both set to one, indicating that the EP table points at the first packet in the stream which is also a first packet of an access unit that is the first to be presented to a user. Here, there is also provided an angle change flag AC which is set to one, which indicates that an angle change can be performed. Angle changes will be described in more detail hereinafter. FIG. 3B shows a second EP-table associated with the second access unit AU2 and pointing at the first video packet of this access unit. This video packet has SPN number 1000 in the transport stream TS1. Here again, there is a presentation time stamp, which in this example is set to two, which indicates that the video information in this access unit will be presented directly after the video information of the first access unit. It should be noted that the presentation order may be different, depending on how the video coding was performed. Also in this case, there is provided an angle change flag AC, which is set to zero. This setting indicates that an angle change cannot be made. As is shown in FIG. 2, there is also an EP-table associated with the third access unit, which is similar in nature to the first and second access units. Furthermore, there are more EP-tables in a stream wherein an EP-table is provided for some access units of a stream and with a small time interval between each EP-table. If a video stream is provided, the table always points at the first video packet of the access unit. If there is no video stream, the table points at the first audio packet of an access unit, and if there is no video or audio stream, there is no EP table at all.

Document EP1 198 133, which is herein incorporated by reference, also describes how transport streams and clip information files can be set up and made to cooperate.

In FIG. 1, a play list PL comprises a number of play items PI, wherein a play item can point at an entry and exit location in a clip information file CI. The play list can then include several play items and, in this way, a number of transport stream sections can be made to be played after each other. FIG. 1, which is merely an example, shows that the first play list PL1 has a first play item PI1 pointing at a first section of the first clip C1 and a second play item PI2 pointing at a second section of the first clip C1. The second play list PL2 has a third play item PI3 pointing at the whole second clip C2, while the third play list PL3 has a fourth play item PI4 pointing at a section of the first clip C1 and a fifth item PI5 pointing at a section of the second clip C2.

Via the play list, it is further possible to select the playing of other streams that are related to a transport stream. One such stream is a text subtitle stream, which is provided as a separate transport stream that is synchronized with the main transport stream. This stream includes a number of packets including text information as well as other information such as definitions of box size, font type and size of characters. This stream also has timing positions provided in the header of each access unit. Another such stream is a different angle of the same video content, i.e. video information shot by another camera. In the present context, the other angle is provided in a different transport stream with a separate clip information file. Here, only the coded video streams differ, but at least the number of other types of streams in the transport streams is the same and hence a play item can refer to two different video streams. In the present invention, angles will be used in a slightly different way than is normally the case.

A user can select to play the media data provided in a clip via selections made in the index table IT. Once such a selection is made, this selection calls upon a movie object MO, which in turn selects a play list PL. Via the play list, the actual content being presented is selected. As mentioned above, a movie object MO is a set of commands executed by the player in which the medium is loaded, wherein one command can call upon a play list PL and order the playing of the content that this play list is pointing at. Another type of command points at another movie object. It is also possible for a movie object to point at an entry in the index table. These types of commands can then be made to jump unconditionally to another movie object, play list, entry in the index table, or resume operation after the actions performed via the index table, movie object and/or play list have been finished. It is further possible to make a jump or selection conditionally based on a comparison of different pieces of information. The movie object also includes commands such as set stream, which is applicable to the different types of streams such as video, audio, presentation graphics and text as well as the interactive graphics stream. This command sets a certain type of stream to be played when a play list is being activated. It should also be realized that there is no one-to-one relationship between movie objects and entries in the index table. The index table calls upon a movie object, but there might be movie objects that entries in the index table do not directly call upon.

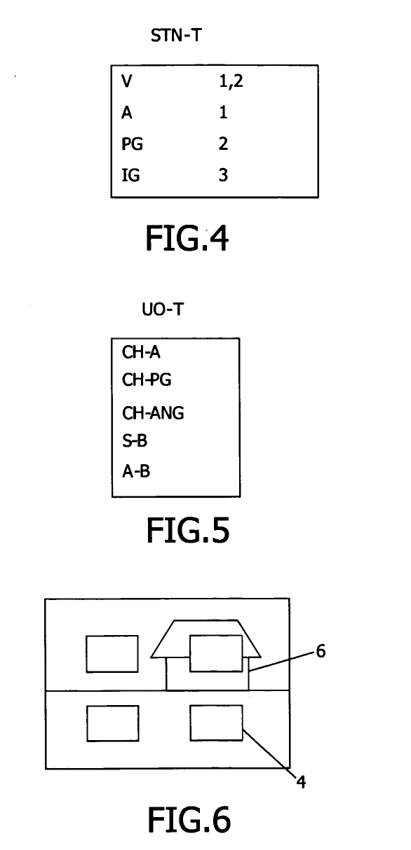

A stream allocation table, which is also called STN table, is associated with each play item PI. FIG. 4 shows an STN table that is associated with a play item PI in FIG. 1. The table shows settings that are allowable for a transport stream of a play item, i.e. which one of the different streams of a clip a user can select and what streams in a transport stream or in more transport streams are associated with each other. The streams set in the table are the streams that are allowed for a user to play. In the table in FIG. 4, a first video stream, a first audio stream, a second presentation graphics and text stream and a third interactive graphics stream are allowed. A setting in the table indicates that these are the only streams allowed to be played by a play item.

FIG. 5 shows a user-operating mask table UO-T associated with a play item. This table has a number of flags, which define if a user is allowed to make changes in relation to certain streams, wherein a first flag CH-A indicates if a user is allowed to change audio streams, a second flag CH-PG indicates if a user is allowed to change the presentation graphics and text stream, a third flag CH-ANG indicates if a user is allowed to change the angle, a fourth flag S-B indicates if a user is allowed to select a button and a fifth flag indicates if a user is allowed to activate a button. Here, the fourth and fifth flags are related to the interactive graphics stream, wherein buttons are provided. The relevance of these buttons will be described hereinafter.

The interactive graphics stream is provided as an overlay screen which can be provided on top of a video stream displaying a number of buttons. The stream comprises a number of graphical objects which are provided as two-dimensional run-length encoded raster images. The stream also comprises control information for placement of images, colors, etc. Some objects in the stream are buttons that are associated with a command script. Such an overlay screen is shown in FIG. 6, which shows a number of buttons 4 provided on top of a video image provided through MPEG coding, which video image here shows a house 6. The overlay image can be set to be displayed at different time positions indicated by time stamps in headers of the first such packet in the access units. As was mentioned above, a number of embedded user-selectable commands in the form of command scripts are associated with these buttons 4, wherein the activation of a button by a user invokes a certain command script. The actual command script associated with a button is normally chosen by the content provider. Thus, there is a number of commands associated with the buttons in the interface graphics stream, which commands are provided in the stream itself. These commands include some of the commands provided for the movie objects, such as the set stream command, but also some other commands and settings are possible, such as branch to play item, jump to another play item in current play list and terminate playing. In normal use of the medium, the whole interactive graphics stream can be inactivated by a user. Thus, a user can normally disable the presentation of the whole stream. Furthermore, a UO-T table is associated also with these command scripts. It should also be realized that there may be more than one interactive graphics stream in a clip.

Now that the general structure of the environment in which the invention is being implemented has been described, a description of the present invention will follow.

When a portable storage medium, such as an optical disc, is provided with media content, it is often advantageous to provide the media data so that a preview copy of the content can be provided. This might be interesting from a promotion point of view, with a potential customer getting to see and hear some of the content on the disc in order to make up his mind if a purchase is interesting or not. Traditionally, this is done by making separate copies of the content, one promotional copy with a limited content and one full copy with all of the content, provided on separate portable storage mediums or discs. The present invention relates to providing the entire content on one disc, i.e. a disc providing both a preview copy and a full copy. However, at least the majority of the content should then be covered, blocked or in any other way made hard to perceive in order to just allow a preview. It should then be possible to remove the protection once a purchase is made.

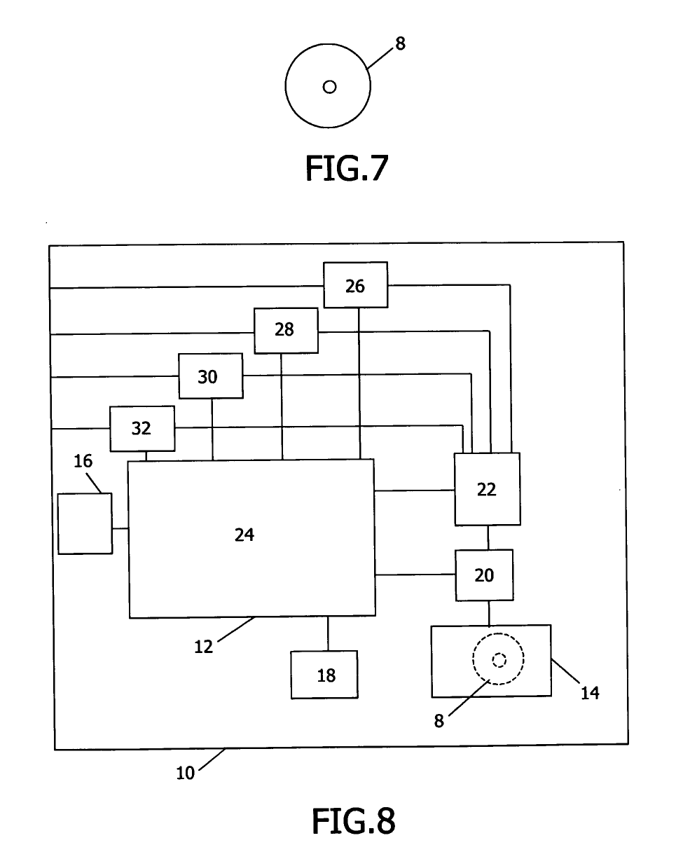

FIG. 7 shows a portable storage medium in the form of an optical disc 8 on which a computer program code enabling the provision of the command structure in layers L1, L2 and L3 of the system in FIG. 1 is stored together with the clips C1 and C2 in layer L4 of the same Figure. The command structure in layers L1 to L3 is then moved to a media player, an example of which is shown in a block diagram in FIG. 8.

The player 10 includes an optical disc drive 14 arranged to receive the disc 8. The device also includes a control unit 12 and a user interface 16 connected to the control unit 12. The disc drive 14 is connected to a reading unit 20 for reading information on the disc 8. The reading unit 20 is further connected to the control unit 12 and to a stream-separating unit 22, which is arranged to receive clips, remove clip information files and supply them to the control unit 12 and separate or demultiplex the media streams that are provided in transport streams into separate media streams. The stream-separating unit 22 is therefore connected to a video decoding unit 32 for decoding MPEG video signals, an audio decoding unit 30 for decoding audio, a graphics processing unit 28 for processing presentation graphics and text streams and to an interactive graphics processing unit 26 for processing interactive graphics streams. The control unit 12 is also connected to all of these units 32, 30, 28 and 26 for controlling them as well as to a status register 18, which stores current status information of the player 10, such as current angle, current audio and current play item.

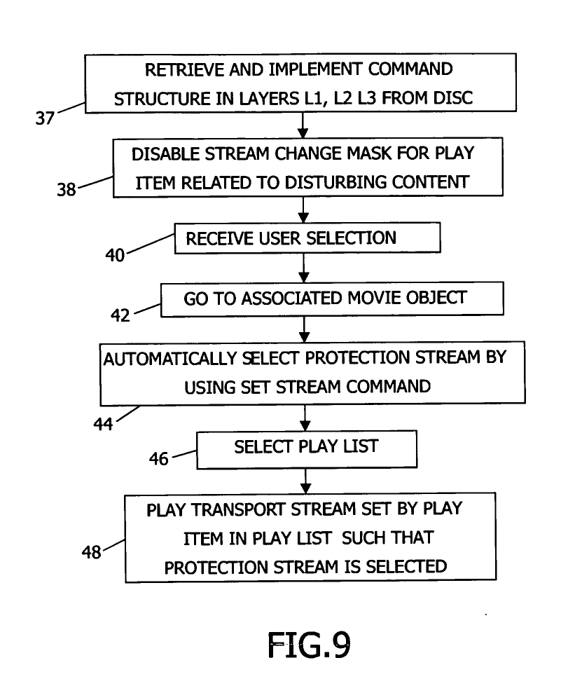

The present invention will now be described with reference to FIG. 9, which is a flow chart of a method according to the invention. First, the control unit 12 retrieves and implements the command structure provided in layers L1, L2 and L3 of FIG. 1 from the disc 8 via the reading unit 20, step 36, such that it can now operate as a playing control unit controlling the presentation of transport streams provided on the disc 8. In the following description, it is assumed that the second movie object MO2, the second play list PL2 and the third play item PI3 are the only parts of the command structure involved in the control of a protection stream or a stream to be used for disturbing the perception of the content. However, it should be realized that more movie objects, play lists and play items might be used for this protection. First, the control unit 12 awaits a user selection via the user interface 14. When a user selection is received, step 38, which user selection is a selection of an item in the index table IT, the control unit 12 selects the movie object associated with the selected table item, step 40, which is the second movie object MO2 in this case. This movie object comprises a set stream command, which automatically sets a stream to be played, i.e. the protection stream, step 42. In this case, it is also possible for the movie object to investigate player status in the status register 18 and select an appropriate protection stream when there is more than one. As will be described below, there are a number of different streams that can be selected as protection streams. The control unit 12 then makes the movie object MO2 select play list, step 44, which is the second play list PL2 in the current example. Then the control unit 12 sets the user-operating table UO-T associated with the play item that is to control a protection stream so that a user cannot influence the protection stream. This is done by setting the appropriate flag associated with the protection stream to disallow changes by the user. In the present example, this is done for the UO-T table of the third play item PI3, step 46. The setting is performed by setting the stream change mask associated with the protection stream. For the third play item PI3, this can be the mask CH-A if the protection stream is an audio stream, the mask CH-PG if the protection stream is a presentation graphics and text stream, or CH-ANG if the protection stream is another angle or video stream. Subsequently, the control unit 12 makes the play item PI3 in the second play list PL2 play the second clip C2, step 48. Because of the set stream command, it is then ensured that a protection stream will be played when the play item starts playing the second transport stream TS2. When a user then tries to play the transport stream TS2, he will automatically get a protection stream played in accordance with the setting in the movie object. This is done by providing the selected streams to respective decoders and showing them on a display and/or providing them to a speaker.

The different steps of the method are also provided in Table I, shown below.

TABLE I

| | |
|---|---|
| 36 | RETRIEVE AND IMPLEMENT COMMAND STRUCTURE IN |
| | LAYERS L1, L2, L3 FROM DISC |
| 38 | RECEIVE USER SELECTION |
| 40 | GO TO ASSOCIATED MOVIE OBJECT |
| 42 | AUTOMATICALLY SELECT PROTECTION STREAM BY |
| | USING SET STREAM COMMAND |
| 44 | SELECT PLAY LIST |
| 46 | DISABLE STREAM CHANGE MASK FOR PLAY ITEM |
| | RELATED TO DISTURBING CONTENT |
| 48 | PLAY TRANSPORT STREAM SET BY PLAY ITEM IN PLAY |
| | LIST SUCH THAT PROTECTION STREAM IS SELECTED |

The user thus selects to play at least a first stream, which may be a video stream V or an audio stream A of the transport stream TS2, but is normally a selection to play both simultaneously. However, then the movie object sets a second protection stream to be played, either instead of the selected first stream or in addition to the selected first stream. In one embodiment, the protection stream is the interactive graphics stream IG and in another embodiment, the protection stream is the presentation graphics and text stream PG both of the same transport stream TS2. In any event, the second stream is of a type provided on the medium for ordinary purposes of presenting information.

Disturbing the perception of content is realized in a simple way by means of the present invention, using the existing command structure provided on a portable storage medium. In this way, it is possible to avoid the use of additional complex measures for disturbing content. This has the further advantage of allowing the content provider full control of the measures performed for disturbing content. The invention also allows the use of the same storage medium for providing preview and full copies of content, which reduces the production costs of such portable storage mediums. Moreover, there is no need for editing the content in order to remove the measure that disturbs the content after a purchase; it can simply be switched off after a verified purchase. Since the second stream is of a type provided on the medium for ordinary purposes of presenting information, a type of stream already provided on a disc for other purposes is used to achieve disturbing of the perception of content. In this way, additional streams and complex additional measures for disturbing the perception of content are avoided.

The protection stream can be provided in a number of ways. According to a first embodiment of the present invention, the protection stream is a certain angle of the video. In this case, the angle is actually not shot from a different camera, but video content is coded with a lower quality. Once a certain piece of video is selected for playing, a change is then made to a different transport stream having the low-quality video.

According to another embodiment of the present invention, the protection stream is a different audio stream, which may be a stream in a language that is different than the normal language or audio having an unintelligible sound. This stream could then be selected to be played instead of the normal audio stream, selected by the user, or in addition to the normal audio stream.

According to another embodiment, the presentation graphics and text stream is used as a protection stream. This stream can then be provided in addition to the user-selected streams.

In one embodiment, the presentation graphics and text stream displays warning messages, such as messages indicating that the content is protected. Another variation is to have said stream provide one or more geometrical shapes such as a rectangle or a triangle, which can also be moved across the ordinary video content.

According to yet another embodiment, a text subtitle stream is used as a protection stream in such a way that texts for subtitles are chosen to include characters that are most disturbing to a user. In this case, characters of a certain type can be used, such as the Webdings type with maximum font size. The subtitle can then also be set to move across the ordinary video content in order to obtain optimal protection.

According to yet another variant of the present invention, the protection stream is the interactive graphics stream, which is provided in addition to the user-selected first stream.

This stream can be provided in such a way that it blocks or does not block the view. The buttons can thus be made transparent, semi-transparent or non-transparent. Furthermore, this stream can be provided in such a way that the buttons are provided very frequently in the stream and a command script is being associated with each of at least one of the frequently recurring buttons. The button is associated with a set stream command and this set stream command is further set in such a way that it is always automatically invoked by the button in question. This means that a command script that acts to disturb the perception of the content is invoked whenever the button in question appears in the stream. By setting the button-related items in the UO-T table of the play item, user influence on the buttons is disallowed. Via a setting in the UO-T table associated with the command script, the user is stopped from being able to remove the automatic selection of the command script. In this case, the command script can be set to change the stream regularly in such a way that, for instance, the video stream is always changed to the low-quality video stream. It is similarly possible to set the other streams mentioned above, i.e. different audio streams, the presentation graphics and text stream and the text subtitle stream as presented. It is also possible to continuously change between different streams whenever such a button appears, for instance, constantly switching between different audio streams, perhaps combined with muting of the sound, or constantly switching between different angles of video. The change of streams using the set stream command is performed by the control unit looking in the status register and changing to a protection stream if it is not the current stream. Another variation is to set a click sound that is associated with the activation or selection of the button. This click sound is then emitted whenever a button is activated or selected, which activation or selection thus takes place automatically and very frequently. This feature can be provided on its own or in combination with any of the above-mentioned protection variations.

It should thus be realized that several of the above-mentioned measures can be combined.

There are a number of further variations that are possible in relation to the present invention. It is possible to combine a protection stream for a part of a clip together with a normal unblocked presentation for another part. One example of this can be seen in FIG. 1, in which the third play list PL3 includes a fourth play item PI4, which may be an item that is directed towards providing protection streams, together with a play item, the fifth play item PI5, which provides unrestricted viewing of content. In this way, it is possible for a user to get unlimited access to some parts of the content together with disturbed content in order to be able to perceive the content for deciding on a purchase or not. Thus, at least a part of a first user-selected media stream gets disturbed by a corresponding part of a second media stream.

Other variations can be made to the present invention, one such variation being that the movie object does not use a set stream command, but instead a setting in the STN table of the play item, defining a protection stream to be presented.

According to the present invention, it is also possible to unlock a disc. If a user has decided to purchase the content, the disc is unlocked by, for instance, the movie object comprising a branching that is made on the basis of purchase verification. If no purchase is made, the set stream command is set for playing the protection stream, whereas no set stream command is set if a purchase is made. In the case of an STN table setting, a movie object activates play items that have protection streams defined in their STN tables if no purchase is made, and play items in which no such STN settings are made are activated if a purchase is made. The set stream command would then not appear in this unlocking sequence. The unlocking sequence can then also be followed or preceded by a resetting of the UO table for allowing all changes to the content.

The control unit is preferably provided in the form of a processor with an associated program memory, which comprises a program code for fetching the command structure, wherein the command structure can be stored for performing the method according to the invention.

The other parts of the player can be implemented in any suitable form including hardware, software, firmware or combinations of these. Especially the decoders and processing units may be provided in hardware. The elements and components of an embodiment of the invention may be physically, functionally and logically implemented in any suitable way. Indeed, the functionality may be implemented in a single unit, in a plurality of units or physically and functionally distributed between different units and processors.

Although the present invention has been described in connection with specific embodiments, it is not intended to be limited to the specific form set forth herein. Rather, the scope of the present invention is limited only by the accompanying claims. In the claims, use of the verb “comprise” and its conjugations does not exclude the presence of other elements or steps. Although individually listed, a plurality of means, elements or method steps may be implemented by e.g. a single unit or processor. Individual features may be included in different claims, but these may be advantageously combined, and the inclusion in different claims does not imply that a combination of features is not feasible and/or advantageous. In addition, singular references do not exclude a plurality. Thus, references to “a”, “an”, “first”, “second”, etc. do not preclude a plurality. Reference signs in the claims are provided merely as a clarifying example and shall not be construed as limiting the scope of the claims in any way.

1. A portable storage medium (8) to be used in a media player (10) for disturbing the perception of content provided in a first media stream (V; A), the medium having stored thereon:
at least one transport stream (TS1) comprising the first media stream combined with other media streams (IG, PG), as well as a second media stream (IG, PG) also provided in a transport stream, and
a computer program code, which, when loaded into the media player, causes said media player to implement
a playing control unit (L1, L2, L3) set to
select, on the basis of a user selection of reproducing content provided in the first media stream, the second media stream for presentation in relation to the first media stream, and
order the presentation of content provided in at least a part of the second media stream in relation to a corresponding part of the first media stream so that the content of the second media stream disturbs the perception of content provided in the first media stream.

2. A storage medium according to claim 1, wherein the second stream is of a type provided on the medium for ordinary purposes of presenting information.

3. A storage medium according to claim 1, wherein the playing control unit comprises a number of command modules (MO1, MO2, MO3), at least one of which (MO2) is activated when a user selects playing of a stream.

4. A storage medium according to claim 3, wherein at least one command module is set to perform said selection and order the presentation.

5. A storage medium according to claim 3, wherein the playing control module further comprises a number of media stream control modules (PL1, PL2, PL3), each media stream control module comprising at least one play item control module (PI1, PI2, PI3, PI4, PI5) that can be activated by a command module and controls the playing of at least a part of at least one transport stream.

6. A storage medium according to claim 5, further comprising a stream allocation table (STN-T) associated with said play item control module and listing allowable streams for the play item control module, wherein the selection of said second media stream is made in dependence upon a setting in said stream allocation table and said ordering of presentation is performed through the command module activating the play item control module.

7. A storage medium according to claim 5, further comprising a user operation table (UO-T) associated with said play item control module, comprising a list of allowable user commands, wherein the user operation table associated with a play item control module (PI3) being controlled by the activated command module (MO2) has at least one setting which disallows the change of commands related to removing the presentation of at least said second media stream.

8. A storage medium according to claim 1, wherein the first media stream is a video stream (V), the second media stream is a stream comprising additional visual information (IG; PG) and the playing control module is arranged to present the second stream over said first stream for disturbing the perception of the content of the first stream.

9. A storage medium according to claim 8, wherein the second stream is a media stream (IG) with embedded user-selectable commands, the commands being set to disturb the perception of the content of the first media stream and disregard user selections.

10. A storage medium according to claim 1, wherein the first media stream is a video stream (V), the second media stream is also a video stream of the same content with a lower quality, and the playing control module is arranged to present the second stream instead of the first stream.

11. A storage medium according to claim 1, wherein the first media stream is an audio stream (A) that is combined with a video stream, the second media stream is also an audio stream, and the playing control module is arranged to present the second stream instead of the first stream for disturbing the perception of content of the first media stream.

12. A media player (10) for disturbing the perception of content provided in a first media stream (V; A), said first media stream being combined with other media streams to at least one transport stream (TS2) and being also provided, together with at least one second media stream (PG, IG), in a transport stream on a storage medium, the media player comprising:
a control unit (12) arranged to retrieve and implement a playing control unit (L1, L2, L3) from said storage medium, which playing control unit is set to
select, on the basis of a user selection of reproducing content provided in the first media stream, the second media stream for presentation in relation to the first media stream, and
order the presentation of content provided in at least a part of the second media stream in relation to a corresponding part of the first media stream so that the content of the second media stream disturbs the perception of content provided in the first media stream.

13. A method of disturbing the perception of content provided in a first media stream (V; A), said first media stream being combined with other media streams (PG, IG) to at least one transport stream and being also provided, together with at least one second media stream (PG; IG), in a transport stream on a portable storage medium (8), the method comprising the steps of:
retrieving a playing control unit (L1, L2, L3) from said storage medium and implementing it, (step 37),
receiving a user selection of reproducing content provided in the first media stream, (step 40),
selecting the second media stream for presentation in relation to the first media stream based on the user selection, (step 44), and
presenting content provided in at least a part of the second media stream in relation to a corresponding part of the first media stream so that the content of the second media stream disturbs the perception of content provided in the first media stream, (step 48).
